(19) United States
(12) Patent Application Publication
(10) Pub. No.: US 2007/0282690 A1
(43) Pub. Date: Dec. 6, 2007

(54) PAYMENT SYSTEMS AND METHODS

(76) Inventors: Joseph R. Randazza, Boca Raton, FL (US); Danilo Portal, Miramar, FL (US)

Correspondence Address: JEROME D. JACKSON (JACKSON PATENT LAW OFFICE), 211 N. UNION STREET, SUITE 100, ALEXANDRIA, VA, 22314, US

(21) Appl. No.: 11/692,172

(22) Filed: Mar. 27, 2007

Related U.S. Application Data
(63) Continuation-in-part of application No. 11/539,636, filed on Oct. 8, 2006.
(60) Provisional application No. 60/724,806, filed on Oct. 11, 2005.
(60) Provisional application No. 60/786,830, filed on Mar. 29, 2006.
(60) Provisional application No. 60/791,217, filed on Apr. 12, 2006.

(51) Int. Cl. G06Q 20/00

(52) U.S. Cl. 705/17

(57) ABSTRACT

Disclosed are payment system and methods.

This Application claims the benefit of U.S. application Ser. No. 60/786,830 of JOSEPH R. RANDAZZA AND DANILO PORTAL Mar. 29, 2006 for PAYMENT SYSTEMS AND METHODS, the contents of which are herein incorporated by reference.

### BACKGROUND OF THE INVENTION

### Field of the Invention

This invention relates generally to payment systems and methods and, more particularly, to payment systems and methods deployed in a retail environment.

### SUMMARY OF THE INVENTION

According to an aspect of the present invention, there is a method for a system having a plurality of persons; a plurality of vehicles; a plurality of cards issued under government authority, each card evidencing a license for a person to operate a vehicle; a routing system for receiving a signal and generating a network address in response to the received signal, the routing system including a plurality of wide area communication links. The method comprises configuring the routing system using a first signal, the first signal corresponding to a signal common to the plurality of cards; receiving a second signal from a first card in the plurality of cards; receiving information corresponding to an account; storing a link between the second signal and the account information. The method further comprises the steps, performed at a point of sale, of: receiving the second signal from the first card; and accessing the account, by using the first signal and the signal received in the previous step.

According to another aspect of the present invention, there is a retail system for a system having a plurality of persons; a plurality of vehicles; a plurality of cards issued under government authority, each card evidencing a license for a person to operate a vehicle; a routing system for receiving a signal and generating a network address in response to the received signal, the routing system including a plurality of wide area communication links. The retail system comprises circuitry for configuring the routing system using a first signal, the first signal corresponding to a signal common to the plurality of cards; circuitry for receiving a second signal from a first card in the plurality of cards; circuitry for receiving information corresponding to an account; circuitry for storing a link between the second signal and the account information; circuitry for rereceiving the second signal from the first card; and circuitry for accessing the account, by using the first signal and the signal received by the previous means.

According to yet another aspect of the present invention, there is a retail system for a system having a plurality of persons; a plurality of vehicles; a plurality of cards issued under government authority, each card evidencing a license for a person to operate a vehicle; a routing system for receiving a signal and generating a network address in response to the received signal, the routing system including a plurality of wide area communication links. The retail system comprises means for configuring the routing system using a first signal, the first signal corresponding to a signal common to the plurality of cards; means for receiving a second signal from a first card in the plurality of cards; means for receiving information corresponding to an account; means for storing a link between the second signal and the account information; means for rereceiving the second signal from the first card; and means for accessing the account by using the first signal and the signal received by the previous means.

### BRIEF DESCRIPTION OF THE DRAWINGS

References are made to the following text taken in connection with the accompanying drawings, in which:

FIG. 1 shows a retail system according to a first exemplary embodiment of the present invention.

FIGS. 2A and 2B show another aspect of the first exemplary system.

FIGS. 3A and 3B show a driver's license card in the first exemplary system.

FIGS. 4A, 4B, and 4C are a flowchart of a process performed in the first exemplary system.

FIGS. 5A, 5B, and 5C show a retail grocery store in the first exemplary system.

FIG. 6 is a diagram showing transaction flows in the first exemplary system.

FIG. 7 shows another retail site in the first exemplary system.

FIG. 8 is a representation of a table in a database in the first exemplary system.

FIG. 9 shows a retail system according to a second exemplary embodiment of the present invention.

FIG. 10 is a diagram showing transaction flows in the second exemplary system.

The accompanying drawings which are incorporated in and which constitute a part of this specification, illustrate embodiments of the invention and, together with the description, explain the principles of the invention, and additional advantages thereof. Certain drawings are not necessarily to scale, and certain features may be shown larger than relative actual size to facilitate a more clear description of those features. Throughout the drawings, corresponding elements are labeled with corresponding reference numbers.

### DETAILED DESCRIPTION OF EXEMPLARY EMBODIMENTS

### First Exemplary Embodiment

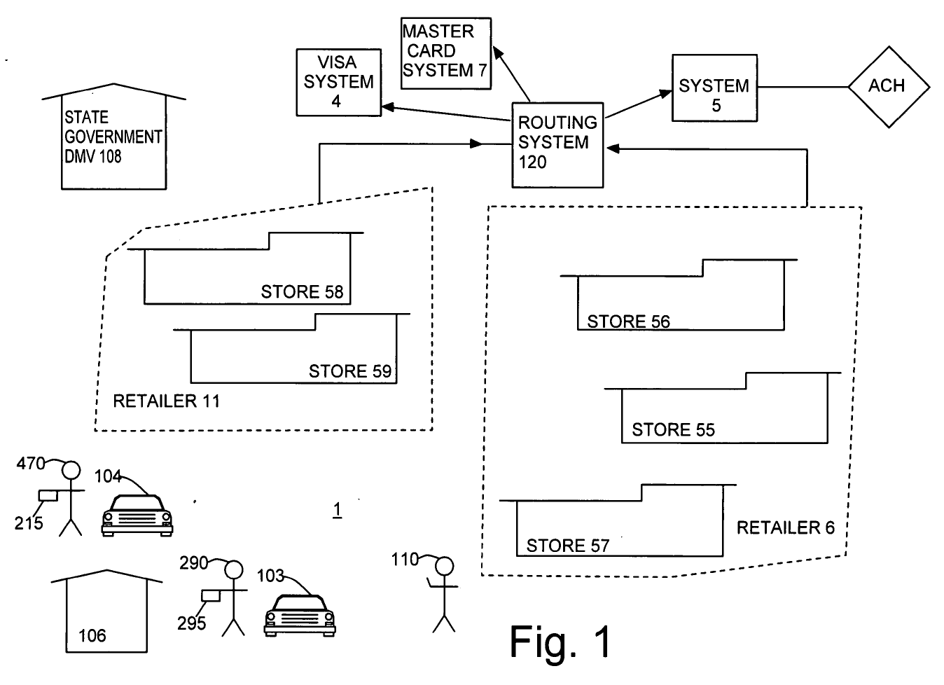

FIG. 1 shows exemplary system 1 according to a preferred embodiment of the present invention. System 1 includes multiple persons, such as person 290 and person 470. System 1 also includes a plurality of vehicles, such as automobile 103 owned by person 290 and automobile 104 owned by person 470. Person 290 operates automobile 103 to travel from her home 106 to various locations, such as her place of employment, and store 55 in retailer 6. Person 290 carries a driver's license card 295 evidencing a license to operate a vehicle such as automobile 103. Person 470 operates automobile 104 to travel from her home to various locations, such as store 55 in retailer 6. Person 470 carries a driver's license card 215 evidencing a license to operate a vehicle such as automobile104.

These licenses and license cards 215 and 295 license were issued under the authority of the Florida Department of Motor Vehicles (DMV) by Motor Vehicle Department 108, which is a part of the Florida State Government. Occasionally, persons 290 and 470 must display their driver's license cards to state officials, such as policeman 110 to prove they are authorized to operate an automobile.

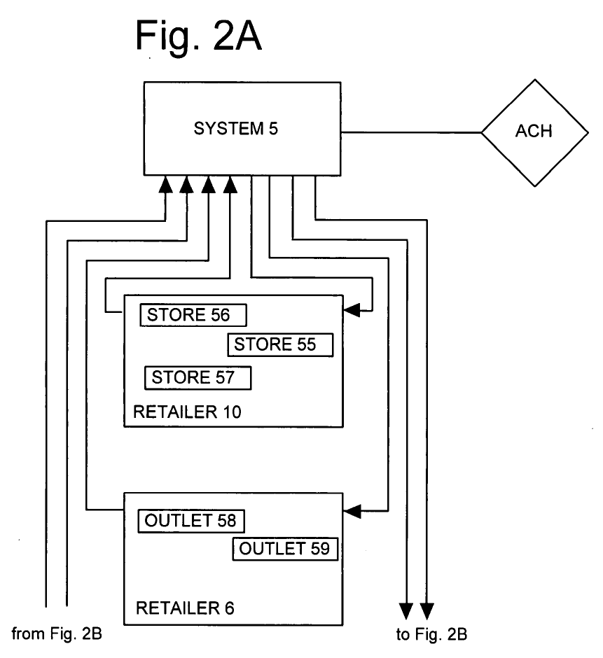

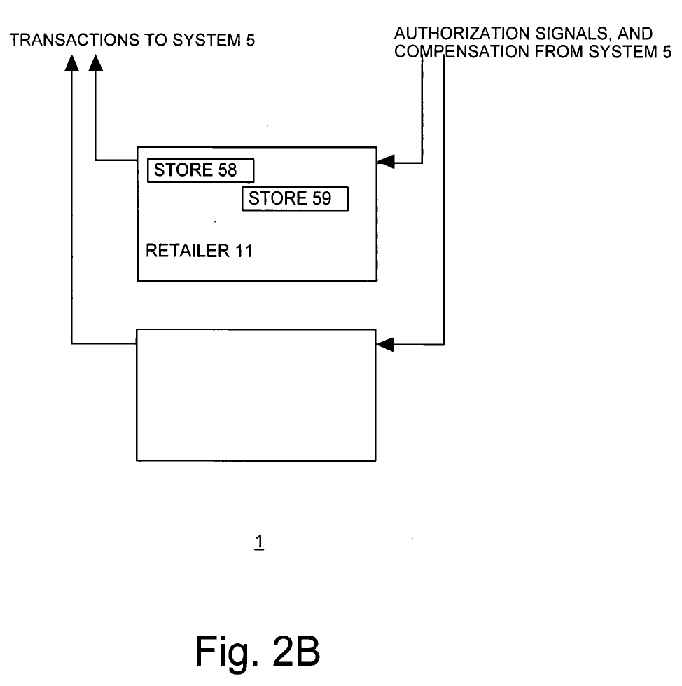

FIGS. 2A and 2B emphasize other aspects of System 1. System 1 includes system 5, which communicates with retailers 6, 10, and 11, via routing system 120. System 5, located in Reston, Va., receives signals from the retailers, to validate customer authorization at the time of a retail transaction, and to debit a customer account later. A signal from a retailer to system 5 is represented by a directed line going from the retailer to system 5; and a signal from system 5 to a retailer is represented by a directed line going from system 5 to the retailer.

In response to a signal from system 5, retailer 6, for example, allows a customer transaction to proceed.

System 5 is owned and operated by a private entity that is under the general control of neither the Florida State Government nor the Virginia State Government. Of course the private entity that owns and controls system 5 may have certain statutory, regulatory, contractual, or common law obligations to these state governments as any persons resident in a state would have.

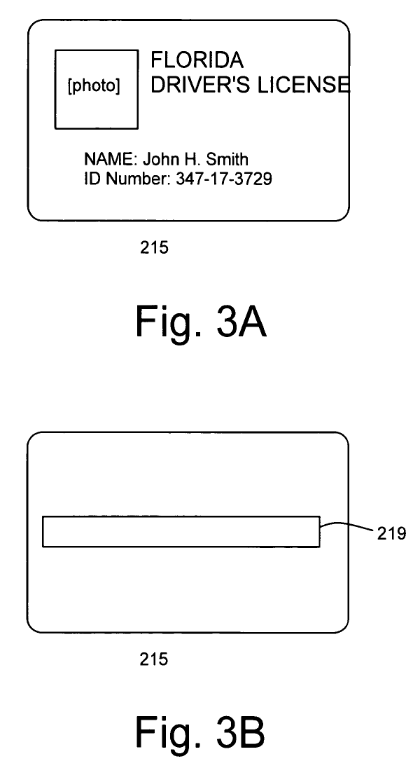

FIG. 3A shows a front, plan view of card 215 carried by person 470, who is a customer in system 1, and FIG. 3B shows a back, plan view of card 215. In this example, card 215 is a state-issued driver's license including a photograph 217 of person 470, and magnetic stripe 219 storing the ID number and other information on the reverse side. Track 2 of stripe 219 also stores the number 636010, indicating the jurisdiction of Florida, in accordance with International Standard ISO 7812.

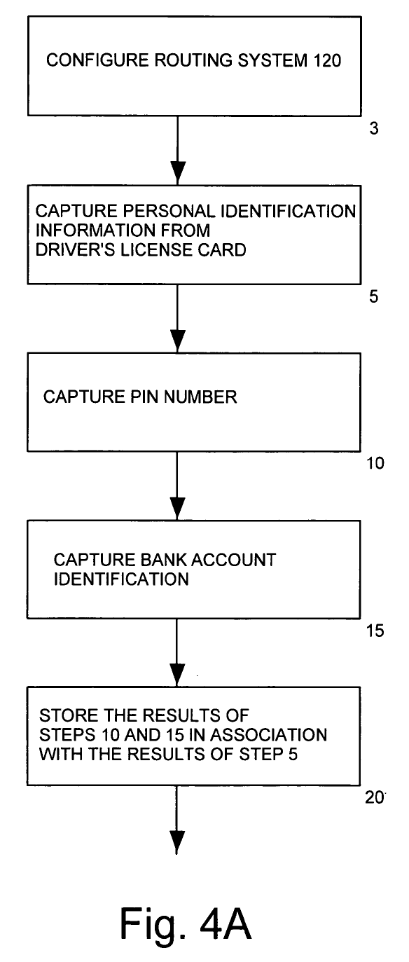

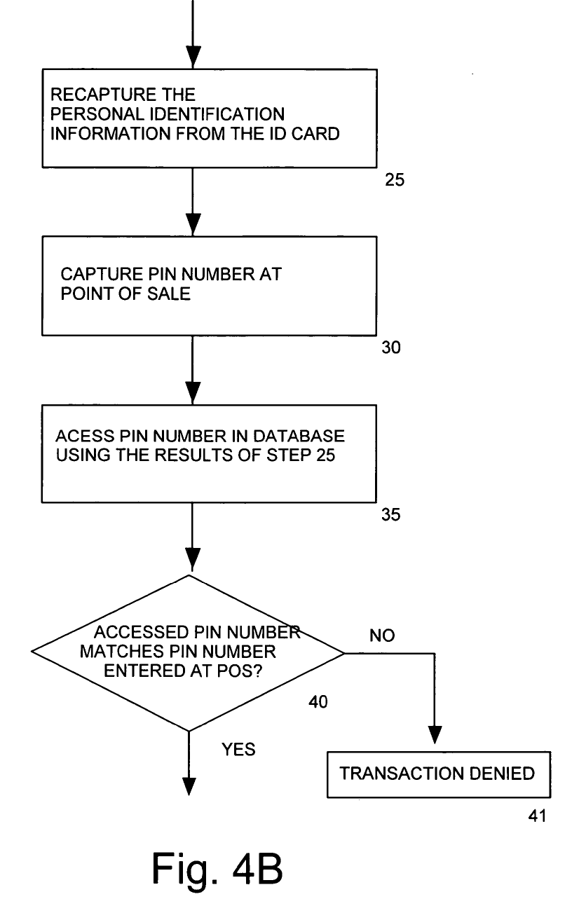

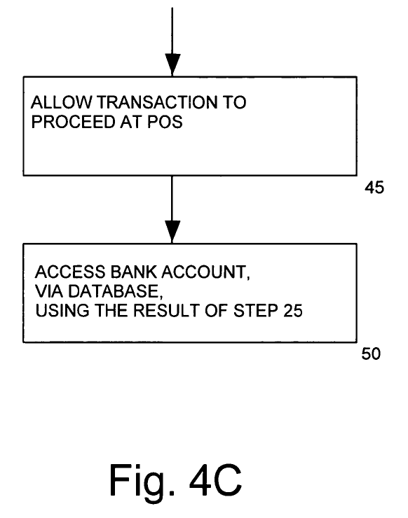

FIGS. 4A, 4B, and 4C show a process performed by circuitry in system 1. Step 3, configuring routing system 120, in accordance with a network address, or network position, of system 5, so that certain signals will be sent to system 5, as described in more detail below.

Steps 5, 10, and 15 are performed for multiple persons, in a store of a retailer, such as retailer 10. In order to enroll in the program, the customer is processed at the retailer customer service area, where the magnetic stripe 219 of card 215 is scanned (step 5), a personal identification number (PIN) entry is received from the consumer into the terminal (step 10), and a personal check is scanned (step 15). The collection of the card identification number, PIN, the bank routing and account number read from the check, then becomes part of transmitted packet to system 5, in which they are stored in association in a database (step 20). The method and protocol for this transmission is TCP/IP.

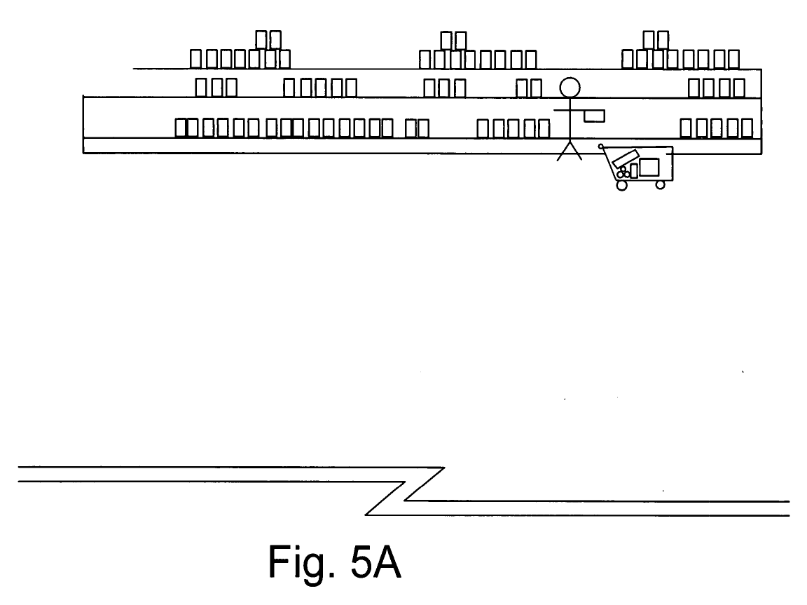

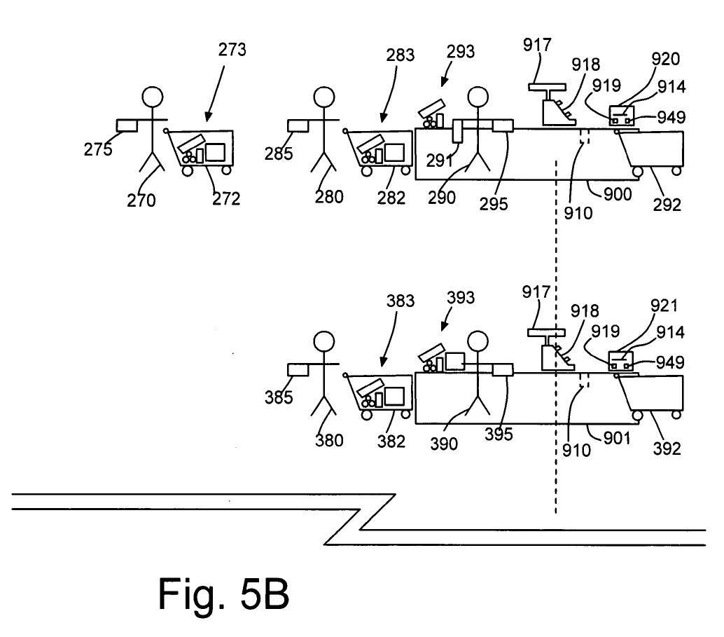

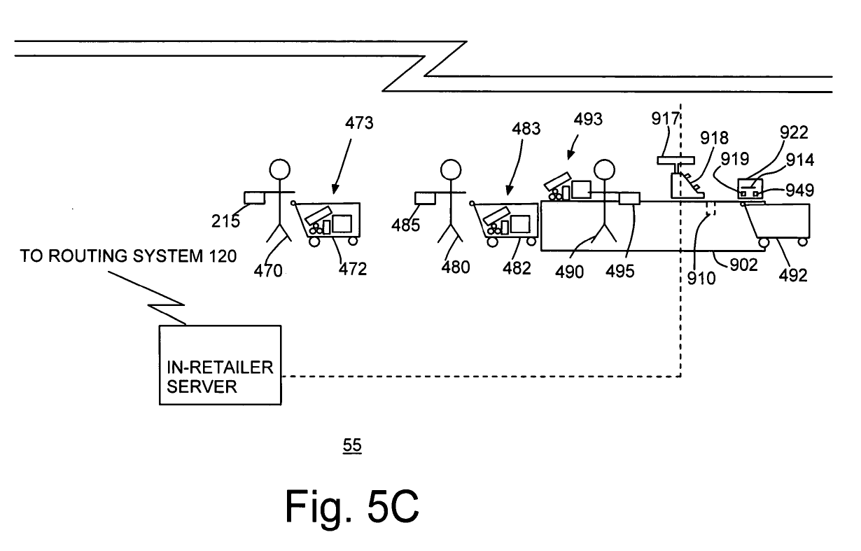

FIGS. 5A, 5B, and 5C show a context in which subsequent steps of the flow chart of FIGS. 4A, 4B, and 4C are performed. FIGS. 5A, 5B, and 5C are each a partial view of store 55 in retailer 10. Store 55 has a plurality of product areas, each corresponding to a respective product, and checkout stations 900, 901, and 902. Each checkout station includes a bar code reader that detects an optical (electromagnetic) signal reflected from a bar code, and a magnetic stripe reader that scans a magnetic card. Checkout station 900 includes payment terminal 920 having a card interface slot 914, checkout station 901 includes payment terminal 921 having a card interface slot 914, and checkout station 902 includes payment terminal 922 having a card interface slot 914. Each payment terminal includes a button 919 labeled “CREDIT” and a button 949 labeled “DEBIT”.

Upon completion of shopping each customer brings selected products from the shelves to checkout station 900, 901, or 902.

Each customer presents her customer card. In this example, customer 490 presents credit card 495, which is associated with an installment payment account of customer 490. Customer 480 presents debit card 485, which is associated with a demand account of customer 480. Customer 470 presents system-5-registered driver's license card 215.

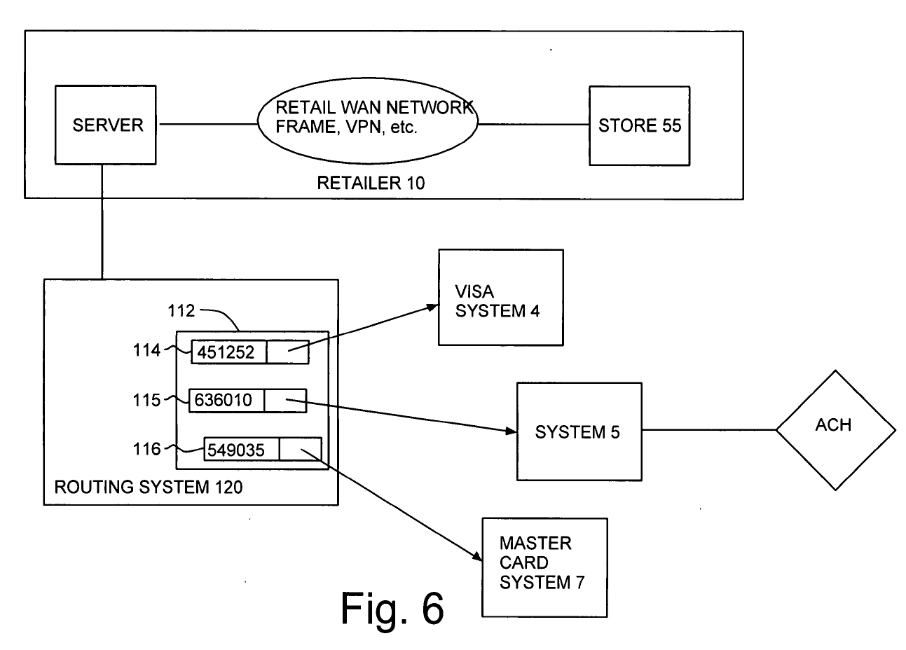

Customer 490 completes the purchase of her selected products 493 by transferring products 493 from her cart 492 to station 902, and by presenting card 495. A checkout clerk (not shown) scans each selected product past bar code reader 910, or enters the product selection information manually via keyboard 918. Checkout station 902 determines a total amount due and prints the total amount due on display 917. Customer 490 activates credit button 919. In response to the activation of credit button 919, circuitry in retailer 10 transmits the account number of card 495 to a credit/debit card authorization provider, such as VISA system 4 shown in FIG. 6, via routing system 120.

In this patent application, the word circuitry encompasses dedicated hardware, and/or programmable hardware, such as a CPU or reconfigurable logic array, in combination with programming data, such as sequentially fetched CPU instructions or programming data for a reconfigurable array.

Customer 480 completes the purchase of her selected products 483 by transferring products 483 from her cart 482 to station 902, and by presenting card 485. The checkout clerk scans selected products past bar code reader 910. Checkout station 902 determines a total amount due and prints the total amount due on display 917. Customer 480 activates debit button 949. In response to the activation of debit button 949, circuitry in payment terminal 922 prompts customer 480 to enter a PIN number into a keypad on terminal 922. Terminal 922 then applies an encryption key to the entered PIN number, to generate an encrypted PIN. Circuitry in retailer 10 then transmits the encrypted PIN and the account number of card 485 to a credit/debit card authorization provider, such as Master Card system 7 shown in FIG. 6, via routing system 120.

Customer 470 completes the purchase of her selected products 473 by transferring products 473 from her cart 472 to station 902, and by presenting driver's license card 215. The checkout clerk scans selected products past bar code reader 910. Checkout station 902 determines a total amount due and prints the total amount due on display 917. Station 902 reads the ID information of person 470 from card 215, and reads the Issuer Identification Number, 636010, indicating the State of Florida, from driver's license card 215. (step 25) (FIG. 3B). Customer 470 or the clerk activates debit button 949. In response to the activation of debit button 949, circuitry in payment terminal 922 prompts customer 470 to enter a PIN number into a keypad on terminal 922. Terminal 922 then applies an encryption key to the entered PIN number, to generate an encrypted PIN number. Circuitry in retailer 10 then transmits the encrypted PIN and the licensee identification of driver's license card 215 to system 5, via routing system 120. At this time the server also transmits retailer ID, store ID date, time, lane ID, cashier ID, transaction amount.

Circuitry in system 5 uses the ID number of the card, transmitted by the server, to access the associated PIN stored in the database. (step 35). System 5 thus compares the PIN, transmitted by the store server, to the PIN read from the database. (step 40). Depending upon the result of step 40, system 5 conditionally responds to the store server with a card-authorized signal, causing station 902 to allow customer 470 to carry away products 473. (step 45).

Otherwise system 5 sends a card-not-authorized signal to the store server.

Step 40 may also include real-time communication to an external database to validate the card against a negative check database.

It is presently preferred that system 5 validate incoming transactions and respond back to the store within several seconds.

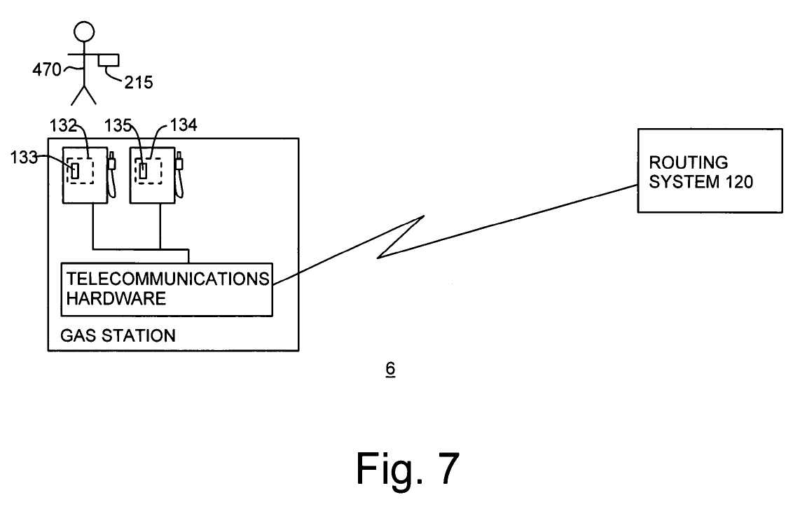

FIG. 7 shows retailer 6 in system 1 in more detail. Retailer 6 is a gas station. Computer system 131 is in the gas station. The gas station includes gas pump point of scale (POS) terminal 132 with card interface 133, gas pump POS terminal 134 with card interface 135, telecommunications circuitry, and a network cable coupling POS terminal 132, POS terminal 134 and telecommunications circuitry together.

Customer 470 buys gas by presenting card 215, either at the payment terminal 132 or elsewhere in the gas station. The gas station reads the ID information from card 215.

Circuitry in system 5 uses the ID number of the card, transmitted by circuitry in retailer 6, to access the associated PIN stored in the database. System 5 conditionally responds to the server in retailer 6 with a card-authorized signal, or a card-not-authorized signal. If the server receives a card-authorized signal, the transaction proceeds and the server then transmits a transaction amount to system 5.

Automated Clearing House (ACH) Settlement transmission occurs daily in batch fashion. (step 50). More specifically, system 5 compiles a file at end of day for submission to the ACH services. The required fields that this file contain are: date, time, transaction type, retailer ID, store ID, bank routing #, bank account #, amount of transaction. The specifics and file format is further defined with the ACH processor.

Status from ACH is collected and logged for review.

FIG. 6 shows another aspect of the first exemplary system, including an in-retailer server that is the gateway of communication leading to routing system 120. Routing system 120 includes a data structure 112, accessed by programs in routing system 120. Data structure 112 allows routing system 120 to select the path of a transaction request packet received from a retailer, as a function of a routing field in the packet. The routing field may contain an issuer identification number (IIN). For example, when routing system 120 receives a transaction request packet containing the number 451252 in the routing field, routing system 120 accesses entry 114, to send the packet to system 4 of the VISA Corporation, allowing system 4 to authorize a credit card transaction. When routing system 120 receives a transaction request packet containing the number 636010 in the routing field, routing system 120 accesses entry 115, to send the packet to system 5. When routing system 120 receives a transaction request packet containing the number 549035 in the routing field, routing system 120 accesses entry 116, to send the packet to system 7 of the Master Card corporation, allowing system 7 to authorize a debit card transaction.

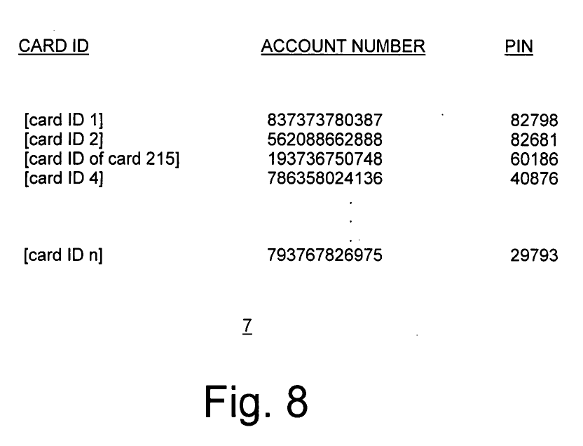

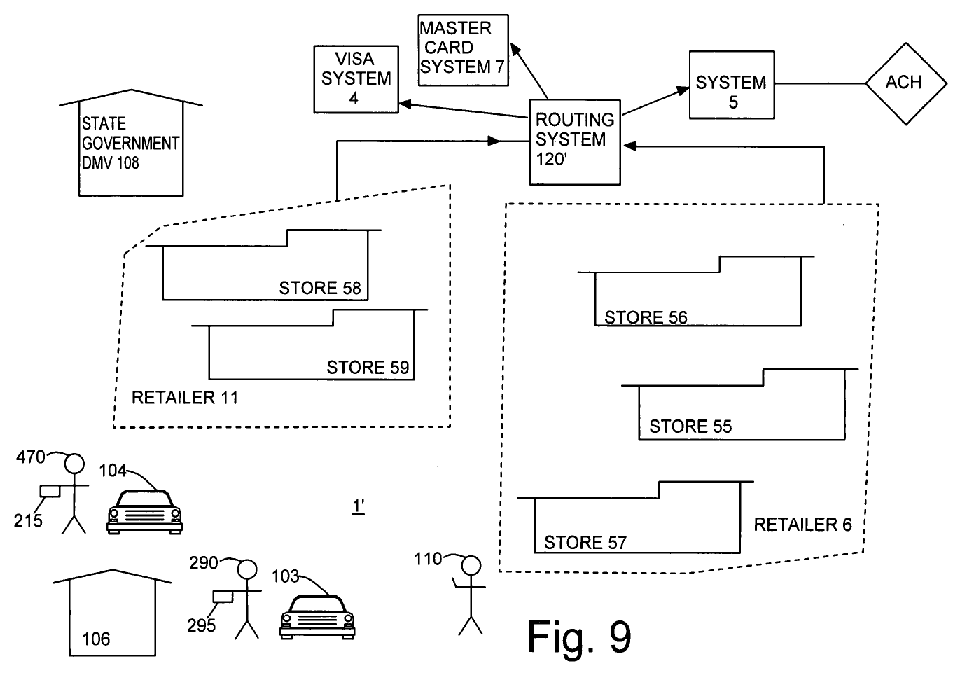

FIG. 8 is a representation of a table 7 in a disk-resident database in system 5. Each row in table 7 is an association between a card ID and other data such as an account number associated with the card ID, and a PIN number associated with the account.

The application will have user interface to activate/inactivate/delete and reissue a card. Transaction logging contains detail information for each payment transaction. For example, the detail includes time stamp: store ID: lane ID: cashier ID: card #: payment amount: swiped vs. bar-coded.

In summary, a point-of-sale payment transaction is effected via a State issued motor vehicle driver's license card and a personal identification number (PIN) as a mechanism of payment for a retail store transaction. A process by which a State issued motor vehicle driver's license is effected to identified a consumer for initiating a payment at the Point of Sale, without the use of any other form of payment.

The POS allows the driver's license to be used as a form of payment to debit a consumer checking account or savings account as a electronic fund transfer using the Federal Reserve Automatic Clearing House (ACH) for settlement.

The system utilizes the driver's license card; a PIN number or Biometric Signature for authentication; POS/payment terminal equipment; a communications network to link to retailers POS system to a ACH host processor; a data base with registered consumers banking information; the ACH system for settlement. The system can be used at any retail facility that installs the system. These include Supermarkets, Convenience stores, gas stations, etc.

The system allows the consumer to enrolled into this system either at a merchant location via an operated by store personnel enrollment software program, a self-service kiosk or via the web.

The consumer enrollment process captures information identifying the consumer, to form an electronic record that is stored in a remote or local computer. Once the enrollment is complete, the consumer can use the driver's license to pay for goods and services at any merchant point of sale location using the process and technology of this system.

System 1 provides a process mechanism (Enrollment) for linking, the consumer driver's license card, based on national standard, magnetic and 2d format to be scanned or swipe, capturing the content of the magnetic data or the decoded barcode data, using a parsing algorithm that presents the data necessary to build the electronic record required by this system. This includes the driver's license number, date of birth, age, address, state issued, date driver's license is issued, date driver's license expires, gender.

Once the driver's license card information is captured, the consumer is asked to enter a PIN. The PIN is encrypted and made part of the electronic record. Next the consumer is asked to present a blank commercial bank check, this check is scanned by check reader that will capture the image of the check, the bank routing number and the bank account. Once the above process is completed the electronic record is formed and stored in a local or remote computer depending on the merchant network infrastructure.

### Second Exemplary Embodiment

FIG. 9 shows exemplary system 1′ according to a second preferred embodiment of the present invention. System 1′ includes routing system 120′.

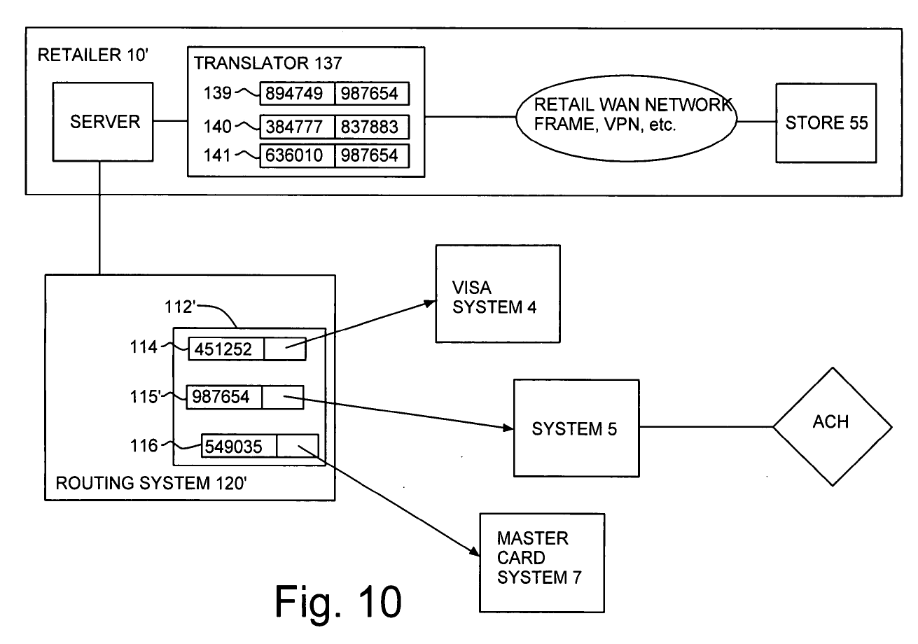

FIG. 10 shows another aspect of the second exemplary system, including circuitry in retailer 10′ that is the gateway of communication leading to routing system 120′. Translator circuitry 137 detects certain Issuer Identification Numbers from cards used by consumers in retailer 10′ and, responsive to such detection, translates to or substitutes a different number. For example, each of entries 139, 140, 141 contains an IIN to be detected on the left half of the entry, and contains a corresponding number to be substituted on the right half of the entry. Software executing in translator 137 examines the left half of the entries. Thus, when a POS in retailer 10′ reads a number driver's license card 636010, indicating the jurisdiction of Florida, translator 137 substitutes the 636010 with 987654.

Routing system 120′ includes a data structure 112′, accessed by programs in routing system 120. Data structure 112′ allows routing system 120′ to select the path of a transaction request packet received from a retailer, as a function of a routing field in the packet. The routing field may contain an issuer identification number (IIN). For example, when routing system 120′ receives a transaction request packet containing the number 451252 in the routing field, routing system 120′ accesses entry 114, to send the packet to system 4 of the VISA Corporation, allowing system 4 to authorize a credit card transaction. When routing system 120 receives a transaction request packet containing the number 987654 in the routing field, routing system 120′ accesses entry 115′, to send the packet to system 5. When routing system 120′ receives a transaction request packet containing the number 549035 in the routing field, routing system 120′ accesses entry 116, to send the packet to system 7 of the Master Card corporation, allowing system 7 to authorize a debit card transaction.

Throughout this patent application, certain processing may be depicted in serial, parallel, multiplexed, or other fashion, for ease of description. Actual hardware and software realizations, however, may be varied depending on desired optimizations apparent to one of ordinary skill in the art.

### Third Exemplary System

System 1 processes driver's license cards using technology similar to a debit card with a pin processing validation via a direct network to a central database. The transactions are processed through the system 5 proprietary circuitry and are submitted for settlement through the Automated Clearing House (“ACH”), which is part of the Federal Reserve System.

System Architecture

The switching of the transaction is performed by the retailer's processor.

System 5 can establish various method of communication with the financial processor:
1. A frame relay connection to the financial processor to support the ISO 8583 host to host communication interface as per the specs outlines in this document.
2. An SSL session via the internet that supports the ISO 8583 format.
3. An https communication via the internet. This method provides a faster implementation, which avoids the set-up of a network infrastructure.
   Enrollment

This process will be done by a client based application running at the store. The enrollment process is not part of the specification for the financial processor, since this one time transaction is only managed directly with system 5.

In order to enroll in the program, the customer will be processed at the retailer customer service area, where the card will be scanned, a pin entry will be asked from the consumer into a pin pad and a personal check will be imaged, the collection of the Loyalty account #, PIN, the bank routing and account number read from the check, will then become part of transmitted packet to the payment host database via a secure SSL connection to system 5 host.

The PC provided by the retailer may have a USB port to attach a check reader and a keyboard inline barcode reader and pin pad.

POS Transaction

The transaction at the POS is effected using some of the circuitry used to effect a debit card transaction. The transaction is tendered as debit payment, the driver's license is swiped at the payment terminal and a prompt for PIN is generated.

The pin is encrypted with the current processor PIN algorithm and flows from the store to the Financial Processor encrypted in similar fashion as for bank debit cards.

Pin Encryption

Services from payment processors—such as First Data, RBSlynk, and Fifth Third—may be configured, as described above, to implement routing system 120.

Pin encryption will follow the current standard use by the payment processor used by the retailers.

Once the transaction signal reaches the processor, the processor will decrypt the pin and re-encrypt using a system 5 key. The transaction is then sent to system 5 for processing.

System 5 will provide software to the processor that will perform this encryption process.

Interface Format

Message Header

Regardless of message format all incoming and outgoing message to National Payment Card switch should have the following message format.

| Field Name | Length | Description |
|---|---|---|
| ID | 2 | Value should always be “NP” |
| Length | 4 | Length of message not including header |
| | | length in network format |

ISO 8583 Format

### Introduction

ISO 8583 specifies a common interface by which financial transaction may be interchanged between financial systems. It specifies messages structure, format and content, data elements and value of data element.

### Message Structure

Each message identified in the ISO is constructed in the following sequence: message header, message type identifier, one or more bitmaps and a series of data elements in order of the bitmap representation.

1. Message Type Identifier

A four digit numeric field describing each message class and function. Every message shall start with a message identifier. Only the message identifier related to this design will be described in this document. Refer to ISO 8583 document for a complete list of all identifiers.

| Message | | |
|---|---|---|
| Type | Description | Originating System |
| 0200 | Authorization Request | Acquirer |
| 0210 | Authorization Response | Card Issuer |
| 0100 | Pre-Authorization Request | Acquirer |
| 0110 | Pre-Authorization Response | Card Issuer |
| 0220 | Completion Request | Acquirer |
| 0230 | Completion Response | Card Issuer |

2. Bitmaps

The second component of each ISO 8583 message is the bitmap of the particular message. Each message may be composed of one or if two bitmaps (If large amount of data needs to be transferred).

The primary bitmap (64 bits) is present in every message. The secondary bitmap is only present if one or more elements with the bitmap number in the ranges of 65-128 are present in the message. Bit 1 in the primary bitmap indicates the presence (1) or absence (0) of the secondary bitmap. In general, frequently used data elements are assigned bitmap number in the range of 1-64.

3. Data Element Format and Attributes

This section describes the format and attributes of data elements.

a. Attribute Type Definition

The following table describes the different attribute type describing data elements.

| Attribute | Description |
|---|---|
| ‘a’ | Alphabetic character |
| ‘b’ | Bitmap |
| ‘n’ | Numeric |
| ‘p’ | Pad character, space |
| ‘s’ | Special character |
| ‘an’ | Alphanumeric |
| ‘as’ | Alphabetic and special character |
| ‘ns’ | Numeric and Special character |
| ‘anp’ | Alphabetic, numeric and pad character |
| ‘ans’ | Alphanumeric and special character |
| ‘z’ | Track 2 data |

b. Attribute Length

The following table describes units used to indicate the size of the elements.

| Type | Unit |
|---|---|
| ‘b’ | Bit |
| ‘n’ | Numeric digit |
| ‘z’ | Track 2 digit |

c. Format Definition

Data elements defined with an entry in the format columns are expressed in a following format.

| Type | Description |
|---|---|
| LL | Unit length of variable data which follows (00-99) |
| LLL | Unit length of variable data which follows (000-999) |
| MM | Month (01-12) |
| DD | Day (01-31) |
| YY | Year (00-99) |
| hh | Hour (00-23) |
| mm | Minute (00-59) |
| ss | Second (00-59) |

4. National Payment Card Supported Data Elements

| Bit | Data Element Name | Format | Attribute |
|---|---|---|---|
| 2 | Card Number | LLVAR | n.. 19 |
| 4 | Dollar Amount | | n12 |
| 11 | POS transaction number | | n6 |
| 12 | Time of Transmission | hhmmss | n6 |
| 13 | Date of Transaction | MMDDYY | n6 |
| 33 | Merchant Code | LLVAR | n.. 11 |
| 32 | Store # | LLVAR | n. 11 |
| 38 | Authorization Code | | an8 |
| 39 | Approval Code | | n.. 3 |
| 41 | POS lane # | | ans8 |
| 42 | Cashier ID | | ans15 |
| 57 | Authorization Life Cycle | LLLVAR | n3 |
| | Length must be 3 | | |
| | postion1=unit type, 0 =no | | |
| | time period, 1=days,2=hours, | | |
| | 3=minutes | | |
| | position 2 and 3 set to value | | |
| | of period | | |
| 58 | User defined field1 | LLLVAR | ans.. 100 |
| 59 | User defined field2 | LLLVAR | ans.. 100 |
| 60 | PIN | LLVAR | an16 |

5. National Payment Card Supported Response Codes

| Approval Code | Description |
|---|---|
| 00 | Transaction submitted Successfully |
| 12 | Invalid Date or time |
| 13 | Invalid or missing amount. |
| 14 | Invalid or missing account number. |
| 32 | Invalid or missing Merchant Code |
| 55 | Invalid data in PIN Number field |
| 76 | Invalid data in User Defined Field 1 |
| 77 | Invalid data in User Defined Field 2 |
| 78 | Cardholder Account On Hold |
| 79 | Cardholder Account Over Velocity Limits |
| 80 | Cardholder Account Blocked |
| 91 | Issuer or switch is inoperative |
| 94 | Duplicate transaction- The transaction was accepted |
| | previously |

### ISO 8583 Messages

1. Authorization Request

The authorization request message may contain the following data elements. The presence of each element will be reflected in the associated bitmap.

| Bit | Element Name |
|---|---|
| | Message Type (0200) |
| | Primary Bitmap |
| 2 | Card Number |
| 4 | Dollar Amount |
| 11 | POS transaction number |
| 12 | Time of Transmission |
| 13 | Date of Transaction |
| 32 | Store # |
| 33 | Merchant Code |
| 41 | POS lane # |
| 42 | Cashier ID |
| 58 | User defined field1 |
| 59 | User defined field2 |
| 60 | PIN |

2. Authorization Response

The authorization response message may contain the following data elements. The presence of each element will be reflected in the associated bitmap.

| Bit | Element Name |
|---|---|
| | Message Type (0210) |
| | Primary Bitmap |
| 2 | Card Number |
| 4 | Dollar Amount |
| 11 | POS transaction number |
| 12 | Time of Transmission |
| 13 | Date of Transaction |
| 32 | Store # |
| 33 | Merchant Code |
| 38 | Authorization Code |
| 39 | Approval Code |
| 41 | POS lane # |
| 42 | Cashier ID |
| 58 | User defined field1 |
| 59 | User defined field2 |

3. Pre-Authorization Request

The pre-authorization request message may contain the following data elements. The presence of each element will be reflected in the associated bitmap.

| Bit | Element Name |
|---|---|
| | Message Type (0100) |
| | Primary Bitmap |
| 2 | Card Number |
| 4 | Dollar Amount |
| 11 | POS transaction number |
| 12 | Time of Transmission |
| 13 | Date of Transaction |
| 32 | Store # |
| 33 | Merchant Code |
| 41 | POS lane # |
| 42 | Cashier ID |
| 57 | Authorization Life Cycle |
| 58 | User defined field1 |
| 59 | User defined field2 |
| 60 | PIN |

4. Pre-Authorization Response

The pre-authorization response message may contain the following data elements. The presence of each element will be reflected in the associated bitmap.

| Bit | Element Name |
|---|---|
| | Message Type (0110) |
| | Primary Bitmap |
| 2 | Card Number |
| 4 | Dollar Amount |
| 11 | POS transaction number |
| 12 | Time of Transmission |
| 13 | Date of Transaction |
| 32 | Store # |
| 33 | Merchant Code |
| 38 | Authorization Code |
| 39 | Approval Code |
| 41 | POS lane # |
| 42 | Cashier ID |
| 58 | User defined field1 |
| 59 | User defined field2 |

5. Completion Request

The pre-authorization completion request message may contain the following data elements. The presence of each element will be reflected in the associated bitmap.

| Bit | Element Name |
|---|---|
| | Message Type (0220) |
| | Primary Bitmap |
| 2 | Card Number |
| 4 | Dollar Amount |
| 11 | POS transaction number (From 0100 message) |
| 12 | Time of Transmission (From 0100 message) |
| 13 | Date of Transaction (From 0100 message) |
| 32 | Store # |
| 33 | Merchant Code |
| 38 | Authorization Code (From 0110 message) |
| 39 | Response Code (From 0110 message) |
| 41 | POS lane # |
| 42 | Cashier ID |
| 58 | User defined field1 |
| 59 | User defined field2 |
| 60 | PIN |

6. Completion Response

The pre-authorization completion response message may contain the following data elements. The presence of each element will be reflected in the associated bitmap.

| Bit | Element Name |
|---|---|
| | Message Type (0210) |
| | Primary Bitmap |
| 2 | Card Number |
| 4 | Dollar Amount |
| 11 | POS transaction number |
| 12 | Time of Transmission |
| 13 | Date of Transaction |
| 32 | Store # |
| 33 | Merchant Code |
| 38 | Authorization Code |
| 39 | Approval Code |
| 41 | POS lane # |
| 42 | Cashier ID |
| 58 | User defined field1 |
| 59 | User defined field2 |

Other systems and options for enrollment and transaction processes may be found in U.S. application Ser. No. 60/724,806 of JOSEPH R. RANDAZZA AND DANILO PORTAL FOR filed Oct. 11, 2005 for PAYMENT SYSTEMS AND METHODS, the contents of which are herein incorporated by reference.

Benefits, other advantages, and solutions to problems have been described above with regard to specific examples. The benefits, advantages, solutions to problems, and any element(s) that may cause any benefit, advantage, or solution to occur or become more pronounced are not critical, required, or essential feature or element of any of the claims.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

What is claimed is:

1. A method for a system having a plurality of persons; a plurality of vehicles; a plurality of cards issued under government authority, each card evidencing a license for a person to operate a vehicle; a routing system for receiving a signal and generating a network address in response to the received signal, the routing system including a plurality of wide area communication links, the method comprising:
configuring the routing system using a first signal, the first signal corresponding to a signal common to the plurality of cards;
receiving a second signal from a first card in the plurality of cards;
receiving information corresponding to an account;
storing a link between the second signal and the account information, and the steps, performed at a point of sale, of:
receiving the second signal from the first card; and
accessing the account, by using the first signal and the signal received in the previous step.

2. The method of claim 1 wherein the first signal includes a signal common to the plurality of cards.

3. The method of claim 1 wherein the first signal is regenerated in response to receiving, at the point of sale, a signal common to the plurality of cards.

4. The method of claim 1 wherein accessing the account includes
receiving the first signal from the first card;
sending the first and second signals into the routing system to allow the routing system to access a routing data structure by using the first signal, and to allow the routing system to send the second signal to an authorization system.

5. The method of claim 1 wherein the account is a demand account.

6. The method of claim 1 wherein accessing includes accessing via the U.S. Automated Clearing House (ACH) system.

7. The method of claim 1 wherein the license is issued by a first state government, and the routing system directs the authorization request to a system in the territory of a second state government.

8. The method of claim 1 wherein the information corresponding to the account includes an account number previously presented to the user on a paper statement generated by the financial institution managing the account.

9. The method of claim 8 wherein the financial institution is a bank.

10. A retail system for a system having a plurality of persons; a plurality of vehicles; a plurality of cards issued under government authority, each card evidencing a license for a person to operate a vehicle; a routing system for receiving a signal and generating a network address in response to the received signal the routing system including a plurality of wide area communication links, the retail system comprising:
circuitry for configuring the routing system using a first signal, the first signal corresponding to a signal common to the plurality of cards;
circuitry for receiving a second signal from a first card in the plurality of cards;
circuitry for receiving information corresponding to an account;
circuitry for storing a link between the second signal and the account information;
circuitry for rereceiving the second signal from the first card; and
circuitry for accessing the account, by using the first signal and the signal received by the previous means.

11. The system of claim 10 wherein the first signal is common to the plurality of cards.

12. The system of claim 10 wherein the first signal is regenerated in response to receiving, at the point of sale, a signal common to the plurality of cards.

13. The system of claim 10 wherein the circuitry for accessing the account includes
circuitry for receiving the first signal from the first card;
circuitry for sending the first and second signals into the routing system to allow the routing system to access a routing data structure by using the first signal, and to allow the routing system to send the second signal to an authorization system.

14. The system of claim 10 wherein the account is a demand account.

15. The system of claim 10 wherein the circuitry of accessing acts via the U.S. Automated Clearing House (ACH) system.

16. The system of claim 10 wherein the license is issued by a first state government, and the routing system directs the authorization request to a system in the territory of a second state government.

17. The system of claim 10 wherein the information corresponding to the account includes an account number previously presented to the user on a paper statement generated by the financial institution managing the account.

18. The system of claim 17 wherein the financial institution is a bank.

19. A retail system for a system having a plurality of persons; a plurality of vehicles; a plurality of cards issued under government authority, each card evidencing a license for a person to operate a vehicle; a routing system for receiving a signal and generating a network address in response to the received signal, the routing system including a plurality of wide area communication links, the retail system comprising:
means for configuring the routing system using a first signal, the first signal corresponding to a signal common to the plurality of cards;
means for receiving a second signal from a first card in the plurality of cards;
means for receiving information corresponding to an account;
means for storing a link between the second signal and the account information;
means for rereceiving the second signal from the first card; and
means for accessing the account, by using the first signal and the signal received by the previous means.
